(19) United States
(12) Patent Application Publication
(10) Pub. No.: US 2026/0113603 A1
(43) Pub. Date: Apr. 23, 2026

(54) Method and Device for Providing Generation Information Relating to a Digital Access Key for a Motor Vehicle

(71) Applicant: Bayerische Motoren Werke Aktiengesellschaft, Muenchen (DE)

(72) Inventor: Matthias FINK, Muenchen (DE)

(21) Appl. No.: 19/361,937

(22) Filed: Oct. 17, 2025

(30) Foreign Application Priority Data
Oct. 18, 2024 (DE) 10 2024 130373.5

(51) Int. Cl. H04W 4/40; B60R 25/24

(52) U.S. Cl. CPC H04W 4/40; B60R 25/24

(57) ABSTRACT

The invention relates to a method and a device for providing generation information relating to a digital access key for a motor vehicle . One form of a method comprises receiving, at a remote computing apparatus, a generation request to generate a digital access key for a motor vehicle, retrieving a generation limit for digital access keys and, when the generation limit has been reached, providing an administration terminal with an approval request, receiving an administrator input by an administration user at the administration terminal, and, when the administrator input comprises an approval of the generation limit, providing generation information for a digital access key by means of the remote computing apparatus.

### CROSS REFERENCE TO RELATED APPLICATION

This application claims priority under 35 U.S.C. §119 from German Patent Application No. DE 102024130 373.5, filed October 18, 2024, the entire disclosure of which is herein expressly incorporated by reference.

### BACKGROUND AND SUMMARY

The invention relates to a method and a device for providing generation information relating to a digital access key for a motor vehicle.

The document DE 102014203060 A1 discloses, for example, a system for exchanging data between at least one vehicle and at least one mobile terminal.

An object of the present invention is to specify an improved method and an improved device for providing generation information relating to a digital access key for a motor vehicle.

This object is achieved, according to forms of the invention, by the subjects of the independent patent claims. The dependent patent claims and the description relate to advantageous embodiments of the invention.

A first aspect provides a method for providing generation information relating to a digital access key for a motor vehicle.

One form of a method according to the invention comprises the steps of receiving, at a remote computing apparatus, a generation request to generate a digital access key for a motor vehicle, retrieving a generation limit for digital access keys, if the generation limit has been reached, providing an administration terminal with an approval request, receiving an administrator input by an administration user at the administration terminal, and, if the administrator input comprises an approval of the generation limit, providing generation information for a digital access key by means of the remote computing apparatus.

Some forms of a method according to the invention is also used, in particular, to administer key generation for a digital access key for one or more motor vehicles and, in particular, to obtain an approval from an administrator if a limit for generating such digital access keys has been reached. Some forms of a method according to the invention also makes it possible, in particular, to make a limit for further key generation dynamic.

For this purpose, a generation request to generate a digital access key for a motor vehicle is first of all received at a remote computing apparatus.

A digital access key is a digitally stored and processed key that provides the user or owner of the key with access functions for one or more motor vehicles, in particular precisely one motor vehicle. These access functions may comprise, in particular, locking and unlocking and/or starting and in particular releasing an engine immobilizer. In particular, these access functions can be coupled to a user, a user terminal and/or a user account, as will also be explained below.

In this case, at least one digital access key for the motor vehicle already exists, in particular before the start of or before carrying out the method, and this primarily involves generating further, additional digital access keys, in which case the first, original digital access key is intended to retain its validity, in particular even during and after the performance of the method.

In order to generate such a further, in particular second or further, for example third or fourth, key, a generation request is received at a remote computing apparatus.

A remote computing apparatus is different, separate and spaced apart from the motor vehicles and any terminals, in particular an administration terminal and/or one or more user terminals, as will also be explained below. The remote computing apparatus may comprise one or more servers which are also partially or completely organized in the cloud. The remote computing apparatus may be operated, in particular, by a manufacturer and/or service provider of the motor vehicle and can be used, for example, to generate and administer one or more digital access keys for one or more motor vehicles.

Such a generation request can be provided or received using a wired and/or wireless communication method, for example using one or more of the following: LAN, WAN, WLAN or WiFi, a mobile radio standard, for example 3G, 4G, 5G, Bluetooth, NFC, and/or Car2X, in particular Car2Infrastructure.

This generation request is received, for example, from a user terminal, in particular a user terminal belonging to a user and/or a user account, seeking or wishing to obtain or generate such an access key, in particular a further digital access key. Such a user terminal is a device, in particular a portable or mobile device, which is different from the motor vehicle. The user terminal is, for example, in the form of a cellphone, a smartphone, a phablet, a tablet and/or a wearable, for example a smartwatch, a Fitbit and/or smart glasses. The user terminal is also but not exclusively used, in particular, to provide interaction functions and in particular such previously described access functions for the motor vehicle, in particular after it has obtained or generated a digital access key.

Alternatively or additionally, the generation request may also be received from a stationary computing unit. The stationary computing unit may be, in particular, a personal computer and/or a terminal which is optionally exclusively provided for administering such digital access keys for one or more vehicles and on which a user requests or applies for generation of a digital access key.

Then, in particular in response to the reception of the generation request, a generation limit for digital access keys is retrieved at the remote computing apparatus. The generation limit may be predetermined, in particular, and/or may depend on further factors, as will also be explained below. In particular, the generation limit may be an integer number and/or zero. In other words, the generation limit may be predetermined in such a manner that initially, without an administrator input described below, no, in particular further, digital access key can be generated. Alternatively, a fixed positive integer number is stored; for example, the generation limit is one, two, three or more.

In this case, the generation limit may be stored in a memory of the remote computing apparatus and may be retrieved from there and/or from a remote location. For example, a blanket generation limit may be stored for a plurality of or all models, vehicles, brands, types of use, users, user terminals and/or user accounts administered by the remote computing apparatus, or different generation limits, which differ in terms of the model, vehicle, brand, type of use, user, user terminal and/or user account, may also be stored, as will also be explained below. Alternatively or additionally, the generation limit may also be received and/or retrieved dynamically and/or in an occasion-related or situation-related manner, as will likewise also be explained below.

If the generation limit has been reached, an administration terminal is provided with an approval request.

In particular, the computing apparatus compares the number of digital access keys that have already been generated, plus the new generation request, with the retrieved or stored generation limit. If the number is greater than the generation limit, the remote computing apparatus provides an administration terminal with an approval request in response to this knowledge. This may likewise be carried out using a wired and/or wireless communication method, as described above.

The administration terminal may be similar to or the same as the user terminal described above. In particular, however, the administration terminal is equipped with additional rights, in particular administration rights, in order to generate an administration approval which is also described below. In particular, the administration terminal is a terminal or a device that comprises a valid digital access key or has access to the latter.

In particular, the administration terminal has a first or original digital access key that is or was at least temporarily the only digital access key and/or on the basis of which or using which a further digital access key is generated, in particular that key which is intended to be generated within the scope of this method.

Alternatively or additionally, the administration terminal may be a device, in particular a device provided exclusively for administration, which does not have a valid access key for the motor vehicle. In particular, it may be a terminal and/or a stationary computing apparatus which is not mobile and/or is not designed and/or configured to trigger functions of the motor vehicle.

For example, the administration terminal may indeed be a mobile smart device, for example also a smartphone, which has an application for communicating with the remote computing apparatus, but does not comprise a valid access key for the motor vehicle. It may likewise be, for example, a conventional personal computer on which communication with the remote computing apparatus and/or another server in contact with the remote computing apparatus can be established by an administration user using a combination of username and password.

If, in contrast, the generation limit has not been reached, generation information for a digital access key, in particular a further digital access key, can be generated on the remote computing apparatus and can be made available to the device from which the generation request was received, in particular a user terminal, alternatively or additionally to the motor vehicle for which the digital access key is intended to be generated, and/or further devices, in particular also the administration terminal.

However, if the generation limit has been reached and the administration terminal has been provided with the approval request, an administrator input by an administration user can be received or captured at the administration terminal in response thereto.

An administrator input may comprise an approval and therefore a cancellation of the generation limit reached or a rejection of an approval and therefore a ban on (further) generation. The administrator input may also explicitly define a new generation limit, for example may generally increase the generation limit, for example by one, two, three or more, or in an occasion-related or situation-related manner. The administrator input may be received, for example, on the administrator terminal on a touchscreen, a hard or soft keyboard, as a voice or gesture input, and can then be made available, as described above, to the remote computing apparatus in a wired or wireless manner. The administrator input is received by an administrator of the administration terminal having, in particular, administrator rights linked, in particular, to an administrator account that has been activated or logged into on the administration terminal. In particular, the administrator or the administration account is in possession of an active or valid digital access key, but need not be.

If the administrator input comprises an approval of the generation limit, the remote computing apparatus generates and provides generation information for a digital access key, in particular a further digital access key. The generation information can be made available, as described above, to the device from which the generation request was received, in particular a user terminal, alternatively or additionally to the motor vehicle for which the digital access key is intended to be generated, and/or further devices, in particular also the administration terminal. A digital access key can then be generated there on the basis of the provided generation information and possibly further information.

In particular, there may also be a certain period of time, for example 1, 2, 6, 12 or 24 hours, between the administrator input or the approval and the actual provision of the generation information or the generation of the digital access key. For example, the generation request may already be made by a user as part of a reservation request for the motor vehicle and the generation information may be provided only with the actual reservation or in response to a further generation request to accept the reservation.

After the generation information has been generated and/or provided, the number of digital access keys generated can be increased, in particular, or the generation limit can be reduced.

Forms of a method according to the invention makes it possible to administer key generation for a digital access key for one or more motor vehicles and to retrieve an approval from an administrator, in particular when a limit for generating such digital access keys has been reached. The method according to the invention also makes it possible, in particular, to make a limit for further key generation dynamic.

According to one development, the method further comprises the step of receiving a generation limit for digital access keys from the administration terminal at the remote computing apparatus, wherein the step of receiving a generation request at the remote computing apparatus is carried out in response to the reception of a generation limit.

According to this development, the generation limit is not or is at least not exclusively predefined, but rather can be or is defined or set by an administrator of the administration terminal. In particular, the administrator can input the generation limit by means of an input on the administration terminal, from which this generation limit is then made available to the remote computing apparatus. This generation limit can be set, in particular, in an occasion-related or situation-related manner. A generation request can then be received in response to the reception of the generation limit or after this in terms of time.

This development makes it possible to generate and restrict digital access keys in a particularly dynamic manner.

According to one development, the method further comprises the step of the administration terminal providing a user terminal with generation information for a digital access key, wherein the generation request received at the remote computing apparatus is based on the generation information from the user terminal.

The administration terminal therefore provides a user terminal with generation information for a digital access key, in particular for the access key described above. This generation information may be different, in particular, from the generation information provided by the administration terminal. In particular, the generation information from the administration terminal and the generation information from the remote computing apparatus can and/or must be used or processed together in order to generate a digital access key.

The generation information received at the user terminal from the administration terminal is used, in particular, to authenticate the user terminal, in particular at the remote computing apparatus. In particular, some or all of the generation information received at the user terminal from the administration terminal may also be made available to the remote computing apparatus, in particular together with the generation request, in order to check or authenticate the user terminal and, in particular, also the generation request at the remote computing apparatus.

This user terminal for which the digital access key is intended to be generated or is generated can be referred to, in particular, as a first user terminal and, in particular, may also itself have rights or options for creating and/or generating generation information for a further digital access key and for making it available, in particular, to a further, second user terminal, in particular when or as long as it itself has a valid digital access key. In particular, however, the first user terminal cannot be equipped with rights or options for confirming, approving and/or changing or defining a generation limit, which can be carried out, in particular, exclusively by the administration terminal.

This development makes it possible to generate and restrict digital access keys in a particularly dynamic manner.

According to one development, the step of receiving a generation limit at the remote computing apparatus is carried out in response to the administration terminal providing the user terminal with generation information for a digital access key.

In particular, the generation limit can be set or defined and made available to the remote computing apparatus at the same time as the generation information is provided by the administration terminal. Occasion-related or situation-related generation limits can therefore be set or defined, in particular.

This development makes it possible to generate and restrict digital access keys in a particularly dynamic manner.

According to one development, the administrator input comprises a signature with a valid digital access key.

The signature may be, in particular, a digital signature which uniquely identifies the administrator or the administrator account on the administration terminal and therefore also authenticates the approval of the generation limit. In particular, the signature may be an asymmetric cryptosystem which can be verified with the aid of a public key that is available to the remote computing apparatus or can be publicly retrieved by the latter.

This development makes it possible to generate digital access keys in a particularly secure manner.

According to one development, the generation limit comprises a generation limit for digital access keys for a predetermined motor vehicle.

In particular, a generation limit for a predetermined motor vehicle is defined here in a situation-related or occasion-related manner. The predetermined motor vehicle may be, in particular, a model, a brand, a type, equipment, a performance and/or a drive type of a motor vehicle relating to or determining the generation limit. In particular, the generation limit comprises a generation limit for digital access keys from a vehicle fleet comprising a plurality of motor vehicles. In this case, the generation limit may relate both to the entire vehicle fleet and to an individual vehicle or selected or certain vehicles from the vehicle fleet.

In other words, a generation limit may depend on the model, etc. for which a generation request is received, and the generation limit can be approved on the basis thereof. In particular, the model, etc. requested by the generation request can be made available, together with the approval request, to the administration terminal, such that an administration user can form an opinion on this and can grant or not grant the approval in this respect.

This development makes it possible to generate and restrict digital access keys in a particularly dynamic manner. In particular, this may make it possible to restrict generation in a particularly efficient manner.

According to one development, the generation limit comprises a generation limit for digital access keys for a predetermined user.

In particular, a generation limit for a predetermined user is defined here in a situation-related or occasion-related manner. The predetermined user may be, in particular, a name, an age, a sex, a user account, a type of use and/or a user terminal affected by or determining the generation limit.

In other words, a generation limit may depend on the user, etc. for whom a generation request is received, and the generation limit may be approved on the basis thereof. In particular, the user, etc. requested by the generation request may be made available, together with the approval request, to the administration terminal, such that an administration user can form an opinion on this and can grant or not grant the approval in this respect.

This development makes it possible to generate and restrict digital access keys in a particularly dynamic manner. In particular, misuse by a user can thus also be restricted or prevented.

According to one development, the generation limit comprises a generation limit for digital access keys for a predetermined period.

In particular, a generation limit for a predetermined period is defined here in a situation-related or occasion-related manner. The predetermined period may be, in particular, a period of time, for example hours, days, weeks, months, a time, for example 7:00, 11:00, 14:00, 16:00, 18:00, 21:00, and/or a time of day, for example in the morning, at midday, in the evening, at night, that is affected by or determines the generation limit.

In other words, a generation limit may depend on the period, etc. for which a generation request is received, and the generation limit may be approved on the basis thereof. In particular, the period, etc. requested by the generation request may be made available, together with the approval request, to the administration terminal, such that an administration user can form an opinion on this and can grant or not grant the approval in this respect.

This development makes it possible to generate and restrict digital access keys in a particularly dynamic manner. In particular, misuse by a user can also be restricted or prevented.

According to one development, the generation limit comprises a generation limit for a predetermined number of digital access keys.

In particular, a generation limit for a predetermined number of digital access keys, in particular a number of digital access keys that may be generated or valid at the same time, is defined here in a situation-related or occasion-related manner. This predetermined number may relate, for example, to a particular user, a particular motor vehicle and/or a predetermined period.

For example, a generation limit for a particular user may comprise the fact that only one, two or three digital access keys for motor vehicles may be generated or valid at the same time for this user. A generation limit for a particular motor vehicle may also comprise, for example, the fact that only one, two or three digital access keys for users may be generated or valid at the same time for this motor vehicle. A generation limit for a particular period may also comprise, for example, the fact that only one, two or three digital access keys may be generated within 1, 2, 6, 12 or 24 hours, for example.

This development makes it possible to generate and restrict digital access keys in a particularly dynamic manner. In particular, misuse by a user may thus also be restricted or prevented.

Two specific exemplary embodiments, which cannot exclude one another, however, and may co-exist, are now explained again.

A first exemplary embodiment relates, in particular, to a private scenario, for example for generating digital access keys for an individual motor vehicle in the family circle and/or among friends.

In this case, in a first step, first generation information for generating a digital access key for a motor vehicle is made available by an administration user of an administration terminal to a first user terminal belonging to a first user. The administration user may be, for example, the owner of the motor vehicle, for example a mother of a family. Alternatively or additionally, the administration user may also be a person in possession of the motor vehicle who is not an owner but is equipped with administration rights, for example a father of a family. The administration user or the administration terminal may be, in particular, in the possession of a valid digital access key for the motor vehicle. The first user is, for example, a first driver, for example a child of a family. In response to the provision of the first generation information, the first user terminal may provide a remote computing apparatus with a generation request to generate or finalize the digital access key for the motor vehicle. For this purpose, the remote computing apparatus provides the first user terminal with further, second generation information for generating the digital access key in response to the generation request.

On account of the property of the administration user or the rights of the latter, a generation limit is not retrieved or checked here and the digital access key is created or finalized on the first user terminal on the basis of the received generation information. The fact that the administration user is equipped with such rights can be included, for example, in the generation information made available to the first user terminal by the administration terminal and/or in the generation request made available to the remote computing apparatus by the first user terminal. However, the first user can be assigned a generation limit which comprises the further generation of digital access keys by the first user or the first user terminal and may also be zero. This generation limit may both be included in the generation information made available to the first user terminal by the administration terminal and/or in the generation request made available to the remote computing apparatus by the first user terminal and may be made available directly to the remote computing apparatus by the administration terminal, in particular with regard to a particular user, here the first user, and/or a particular motor vehicle. Further limits may also be determined, such as a predetermined period in which a digital access key can be generated or a predetermined number of digital access keys which can be generated, in particular again with respect to a particular user and/or a particular motor vehicle. It is assumed below that the generation limit for the first user and the motor vehicle is not zero, but rather in particular one, that is to say he can or may generate a further digital access key for the motor vehicle without approval by the administration user.

In a further step, the first user of the first user terminal may now provide a second user or a second user terminal with generation information for generating a further digital access key for the same motor vehicle. A conceivable scenario here is, for example, that the child of a family has suffered a breakdown with the motor vehicle and would like to generate a further digital access key for a breakdown mechanic. In this case, the generation information may again comprise a generation limit for the second user or the second user terminal. Alternatively or additionally, a predetermined generation limit for further digital access keys may be stored, for example in the remote computing apparatus.

In response to the provision of the first generation information, the second user terminal then provides the remote computing apparatus with a generation request to generate or finalize the further digital access key for the motor vehicle. A generation limit is then retrieved and checked here. Since the generation limit for the first user terminal or the first user was set here to one with or after the generation of the digital access key, the generation information for the further digital access key for the second user or the second user terminal may be generated by the remote computing apparatus. This further digital access key or the second user and/or the second user terminal may then also be provided with a generation limit again, which may also be zero, for example.

However, it may also be assumed, by way of example, that the generation limit for the first user or the first user terminal for generating further digital access keys has already been reached and/or is zero. This may be checked in various ways. For example, the first user terminal may already provide the remote computing apparatus with a generation request before the first generation information is intended to be made available to the second user terminal and, if the generation limit has been reached, the generation information cannot be made available to the second user terminal at all by the first user terminal. Alternatively or additionally, this may be checked in connection with the generation request for the remote computing apparatus from the second user terminal. For this purpose, the generation information made available to the second user terminal by the first user terminal may comprise, for example, a link and/or a URL which provides the remote computing apparatus with the generation request when called up on the second user terminal.

If, in any case, the generation limit has now been reached, an approval request may be made available to the administration terminal by the remote computing apparatus in response to the generation request. The administration user can then provide the administration terminal with an administrator input comprising an approval or refusal of the generation or the generation limit. If the administrator input does not comprise an approval, no generation information will be made available to the second user terminal by the remote computing apparatus and the further digital access key cannot or is not generated on the second user terminal. However, if the administrator input comprises an approval, the generation information is made available to the second user terminal by the remote computing apparatus. After this, the method is concluded or can start again from the beginning in response to generation information being made available to a further, third user terminal by the second user terminal.

A further exemplary embodiment relates to a commercial scenario, for example for generating digital access keys for one or more motor vehicles from a vehicle fleet comprising a plurality of motor vehicles for one or more users, for example for fleet administration, in particular of a vehicle rental service.

For this purpose, in particular before carrying out the method, one or more motor vehicles have been added to a vehicle fleet administered on the remote computing apparatus, for example by an administration user on the administration terminal. The administration user or the administration terminal does not itself have a valid digital access key for the motor vehicle(s) in the vehicle fleet, but is equipped with rights for approving generation of one or more digital access keys. In particular, a valid digital access key is stored for each added motor vehicle in the vehicle fleet on the remote computing apparatus. The remote computing apparatus, in particular, also stores the basic authorization and one or more further digital access keys for each digital access key stored there, in particular irrespective of the actual generation limit. One or more users who are able or wish to access the vehicle fleet are also stored, in particular with individual generation limits for each user, which can also be set across the board or preset, however.

In a first step of the method, a generation request to generate a digital access key for a motor vehicle from the vehicle fleet is then received at a first user terminal from a first user, and this generation request is made available to the remote computing apparatus. This may be carried out, in particular, during a reservation request for a specific or generic motor vehicle from the vehicle fleet. A generation limit, in particular for the specific user and/or the specific motor vehicle, is then retrieved on the remote computing apparatus and a check is carried out in order to determine whether or not this limit has already been reached. If it has not been reached, generation information for generating a digital access key is made available to the first user terminal by the remote computing apparatus. This can be effected both immediately in response to the generation request or the reservation request or only at a later time or with a delay, for example at the time of the reservation itself, in particular in response to a new generation request from the first user terminal.

However, if the generation limit has been reached, which may be zero across the board in particular in the present case, for all motor vehicles from the vehicle fleet and/or for all users, an approval request to approve or refuse generation or the generation information by an administrator input is made available to the administration terminal or an administration user by the remote computing apparatus. If the administrator input comprises a refusal, no generation information is made available to the first user terminal by the remote computing apparatus and the digital access key cannot or is not generated for the first user terminal. However, if the administrator input comprises an approval, the generation information, which may also comprise the digital access key itself in particular, is made available to the first user terminal by the remote computing apparatus. After this, the method is concluded or can start again from the beginning in response to a generation request from a further, second user terminal belonging to a further, second user.

A further aspect specifies a device comprising means for carrying out or at least causing an embodiment of the method described above.

In particular, the device comprises one or more processor apparatuses for carrying out the method described above. The device also comprises, in particular, a memory, in which code is stored, in particular in a non-volatile memory, which code, when executed by a processor apparatus, causes the latter to carry out the method described above.

In particular, the device may comprise the administration terminal, the first user terminal, the second or further user terminals, the motor vehicle and/or the remote computing apparatus, may form a system therewith and/or may interact therewith in order to carry out the method described above.

Further features of the invention emerge from the claims, the figures and the description of the figures. The features and combinations of features mentioned above in the description and the features and combinations of features mentioned below in the description of the figures and/or shown in the figures alone can be used not only in the respectively stated combination, but also in other combinations or alone.

The invention is now explained in more detail using a preferred exemplary embodiment and with reference to the drawings, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic perspective view of an embodiment of a method and a device for providing generation information relating to a digital access key for a motor vehicle; and

FIG. 2 shows a schematic flowchart of an embodiment of a method from FIG. 1.

### DETAILED DESCRIPTION OF THE DRAWINGS

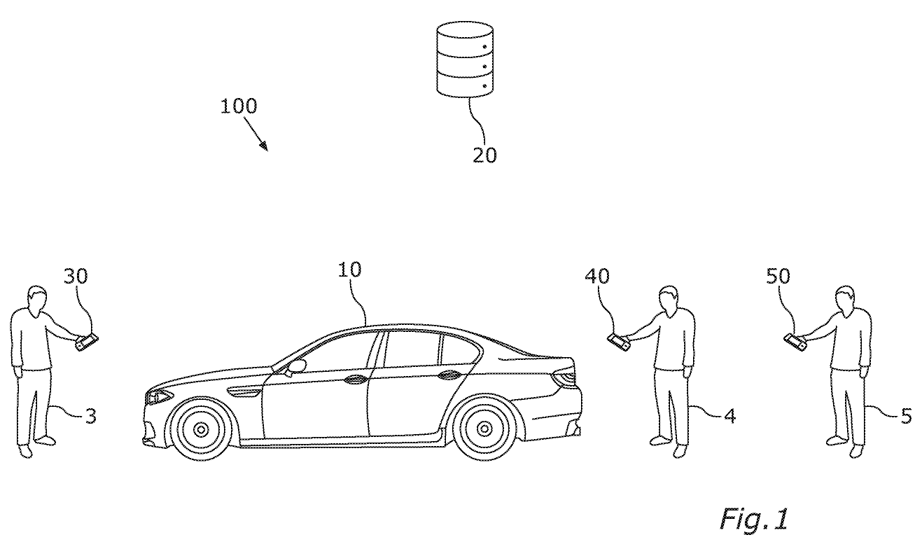

FIG. 1 shows a schematic perspective view of an embodiment of a method and a device 100 for providing generation information relating to a digital access key for a motor vehicle 10.

The device 100 may comprise at least one remote computing apparatus 20 and is designed to carry out or at least cause the method described below. For this purpose, the device 100 has a wireless communication connection to an administration terminal 30, which is operated by an administration user 3, and also to a first user terminal 40, which is operated by a first user 4, and a second user terminal 50, which is operated by a second user 5.

For this purpose, the device 100 is first of all designed to receive, at the remote computing apparatus 20, a generation request to generate a digital access key for the motor vehicle 10.

The device 100 is also designed to retrieve a generation limit for digital access keys.

The device 100 is also designed to provide the administration terminal 30 with an approval request if the generation limit has been reached.

The device 100 is also designed to receive an administrator input from the administration user 3 at the administration terminal 30.

The device 100 is also designed to provide generation information for a digital access key by means of the remote computing apparatus 20 if the administrator input comprises an approval of the generation limit.

The device 100 is also designed to receive the generation limit for digital access keys at the remote computing apparatus 20 from the administration terminal 30, wherein a generation request is received at the remote computing apparatus 20 in response to the reception of a generation limit.

The device 100 is also designed to provide the first user terminal 40 with generation information for the digital access key from the administration terminal 30, wherein the generation request received at the remote computing apparatus 20 is based on the generation information from the user terminal 40.

The device 100 is also designed to cause a generation limit to be received at the remote computing apparatus 20 in response to generation information for a digital access key being made available to the first user terminal 40 by the administration terminal 30.

The administrator input may comprise, in particular, a signature with a valid digital access key.

The generation limit may comprise a generation limit for digital access keys for a predetermined motor vehicle, for a predetermined user, for a predetermined period and/or for a predetermined number of digital access keys.

The administration terminal 30 may have, in particular, a first, in particular the first, valid digital access key for the motor vehicle.

Based on this first valid digital access key, generation information for a second digital access key can then be made available to the first user terminal 40 by the administration terminal 30.

Based on the generation information for the second digital access key, the first user terminal 40 can then request further generation information from the remote computing apparatus 20 with the aid of a generation request.

After a generation limit has been checked and possibly approved by the administration terminal 30, the further generation information can then be made available to the first user terminal 40 by the remote computing apparatus 20 and a second valid digital access key for the motor vehicle 10 can be generated, on the basis thereof and the generation information previously generated by the administration terminal 30, on the first user terminal 40.

Based on this second valid digital access key, the second user terminal 50 can then generate generation information for a third digital access key and make it available to the second user terminal 50.

The second user terminal 50 can then, on the basis of the generation information for the third digital access key, request further generation information from the remote computing apparatus 20 with the aid of a generation request.

After a generation limit has been checked and possibly approved by the administration terminal 30, the further generation information can then be made available to the second user terminal 50 by the remote computing apparatus 20 and a third valid digital access key for the motor vehicle 10 can be generated, on the basis thereof and the generation information previously generated by the first user terminal 40, on the second user terminal 50.

In other words, although it is possible for a user terminal in a chain to generate generation information for a further digital access key on the basis of a valid digital access key, final generation of a further digital access key, if a generation limit that may also be zero has been reached, is possible only after prior approval by the administration terminal.

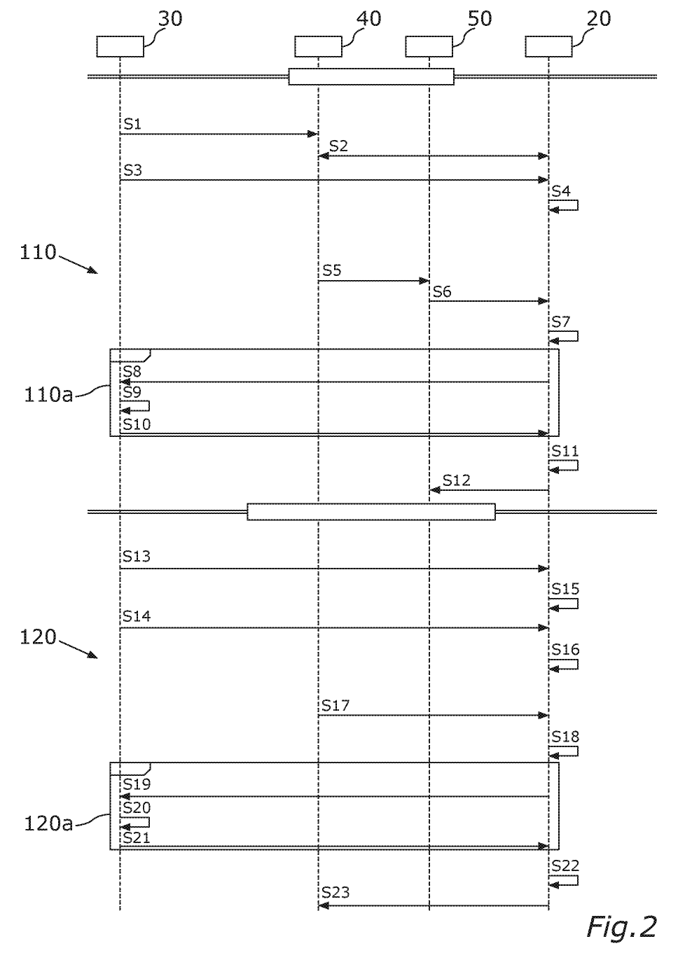

FIG. 2 shows a schematic flowchart of an embodiment of a method for providing generation information relating to a digital access key for a motor vehicle 10 from FIG. 1.

The flowchart in this FIG. 2 is subdivided into four sections: a first section relating to actions or method steps with respect to an administration terminal 30 and/or an administration user, a second section relating to actions or method steps with respect to a first user terminal 40 and/or a first user, a third section relating to actions or method steps with respect to a second user terminal 50 and/or a second user, and a fourth section relating to actions or method steps with respect to a remote computing apparatus 20.

The administration user who interacts with the administration terminal may be, in particular, an owner and/or administrator of the motor vehicle, the first user may be, in particular, a driver of the motor vehicle, and the second user may be, in particular, a third party seeking entry or access to the motor vehicle.

The flowchart according to this FIG. 2 describes two different embodiments for providing generation information: a first type of generation 110, with an alternative 110a, describing, in particular, generation of a digital access key for private or personal use for an individual or single motor vehicle, and a second type of generation 120, with an alternative 120a, describing, in particular, generation of a digital access key for industrial or commercial use which can also relate, in particular, to a vehicle fleet comprising a plurality of motor vehicles, for example belonging to a commercial owner and/or renter. It goes without saying that both embodiments can be combined with one another and do not exclude one another.

In the first type of generation 110, generation information for generating a digital access key for the motor vehicle is first of all made available to the first user terminal 40 belonging to the first user by the administration terminal 30 belonging to the administration user in a first step S1. This can be carried out, in particular, in response to an administrator input on the administration terminal by an administration user. This generation information forms only part of the information needed to generate a digital access key for a motor vehicle or to complete the generation. In particular, further generation information is also required for this purpose and is made available to the first user terminal 40 by the remote computing apparatus 20, as will also be explained below. For this purpose, in a further step S2, the first user terminal 40 provides the remote computing apparatus 20 with a generation request. This can be carried out, in particular, in response to a user input and/or user operation by the first user of the first user terminal 40, in particular in such a manner that further generation information is intended to be retrieved. This can be carried out, in particular, by calling up a URL or a link which was made available to the first user terminal 40 by the administration terminal 30 as part of the generation information and can refer to the remote computing apparatus 20 and can include, in particular, further information, in particular also generation information. In response to the generation request, a generation limit for digital access keys for the motor vehicle can already be retrieved here on the remote computing apparatus 20 and further generation information can be made available to the first user terminal 40 by the remote computing apparatus 20 in the same step S2 only if the generation limit has not yet been reached. Alternatively, however, this can be dispensed with on account of the fact that the generation information is made available to the first user terminal 40 by the administration terminal 30 or by the administration user. In particular, in this step S2, further information, in particular additional and/or supplementary generation information, can also be exchanged or provided between the administration terminal 30, the first user terminal 40 and the remote computing apparatus 20, in particular also using further remote computing apparatuses, such as one or more servers not shown here. A digital access key for the motor vehicle can then be generated on the first user terminal 40 on the basis of the generation information provided by the remote computing apparatus 20 and additionally on the basis of the generation information provided by the administration terminal 30. In particular, the digital access key for the motor vehicle may be finalized or completed on the basis of the generation information from the remote computing apparatus 20.

In a further step S3, which can also be carried out in particular at the same time as steps S1 and/or S2, a generation limit for generating digital access keys for the motor vehicle is then received at the administration terminal 30 by an administration user and is made available to the remote computing apparatus 20. This generation limit may relate, in particular, to the particular first user and/or the particular first user terminal 40 and, in particular, also the generation for further digital access keys starting from or on the basis of the digital access key generated for the first user of the first user terminal 40.

In a further step S5, generation information for a further digital access key is then made available to the second user terminal 50 from the first user terminal 40 by the first user of the first user terminal 40. This can be carried out, in particular, in response to a user input by the first user on the first user terminal 40. This can again be carried out, in particular, in response to a user input and/or user operation by the second user of the second user terminal 50, in particular also in such a manner that further generation information is intended to be retrieved. This can be carried out, in particular, by calling up a URL or a link which was made available to the second user terminal 50 by the first user terminal 40 as part of the generation information and can refer to the remote computing apparatus 20 and can contain, in particular, further information, in particular also generation information. In this case too, further generation information is again required from the remote computing apparatus 20, which is why, in a further step S6, the second user terminal 50 provides the remote computing apparatus 20 with a generation request. In particular, further information, in particular additional and/or supplementary generation information, can also be exchanged or provided in this step S6, in a similar manner to step S2, between the administration terminal 30, the first user terminal 40, the second user terminal 50 and the remote computing apparatus 20, in particular also using further remote computing apparatuses, such as one or more servers not shown here. In response to this, the generation limit previously received from the administration terminal 30 is retrieved and checked. If the generation limit for the motor vehicle, the first and/or second user and/or the first and/or second user terminal 40, 50 has not yet been reached, generation information is made available to the second user terminal 50 by the remote computing apparatus 20, which is not explicitly shown here in a step.

However, if the generation limit has been reached, an approval request is made available to the administration terminal 30 by the remote computing apparatus 20 and is received at the administration terminal in a further step S8 in the alternative 110a. In response to this, an administrator input by the administration user, comprising an approval of the generation limit, which is signed with a valid digital access key, is received in step S9 at the administration terminal 30. This approval is then made available to the remote computing apparatus in a further step S10. In response to this, in a step S11, the approval and the new digital access key to be generated for the second user terminal 50 are then noted and, in response to this, the requested generation information is made available to the second user terminal 50 in a further step S12 in order to complete the digital access key here. Only generated digital access keys of this kind can be used to trigger a function on the motor vehicle, for example the unlocking of a door and/or an engine immobilizer.

In the second type of generation 120, at least one motor vehicle is first of all added to a vehicle fleet in a first step S13 on the remote computing apparatus 20, where this vehicle fleet is also administered. The vehicle fleet may comprise at least one further vehicle, in particular a plurality of further vehicles. The addition can be carried out by means of an administrator input by the administration user on the administration terminal 30 and may be made available to the remote computing apparatus 20, wherein, in response to this, in a further step S14, the motor vehicle or the added vehicles is/are added to the vehicle fleet on the remote computing apparatus 20.

In a further step S15, the first user is equipped with usage rights for at least one motor vehicle, in particular the previously added motor vehicle, in the vehicle fleet on the remote computing apparatus 20. This can also be carried out by means of an administrator input by the administration user on the administration terminal 30 and may be made available to the remote computing apparatus 20. A plurality of users may also be equipped with usage rights for one or more vehicles in the vehicle fleet, for example at least one further user, for example the second user. In response to this, the first user or the added users with the equipped rights is/are then included in the vehicle fleet as user(s) in a further step S16 on the remote computing apparatus.

In a further step S17, a generation request to create a digital access key for a motor vehicle, in particular the previously added motor vehicle, is received from the first user at the first user terminal 40, which request is made available to the remote computing apparatus 20 and is received there. In response to this, in a further step S18, a generation limit for digital access keys is retrieved on the remote computing apparatus 20 and a check is carried out in order to determine whether there is a generation limit for the particular requested motor vehicle, for the particular first user and/or for the particular first user terminal 40 and whether a digital access key may or can be generated as requested. If the generation limit has not been reached, generation information is made available to the first user terminal 40 by the remote computing apparatus 20, which is not explicitly shown here in a step. In particular, this generation information is sufficient to generate a digital access key for the first user terminal 40 or comprises this key and, in particular, no further generation information is needed to complete or finalize the digital access key, in particular not from the administration terminal 30.

However, if the generation limit has been reached, an approval request is made available to the administration terminal 30 by the remote computing apparatus 20 and is received at the administration terminal in a further step S19 in the alternative 120a. In response to this, an administrator input by the administration user, comprising an approval of the generation limit, which, unlike the type of generation 110, is not signed here with a valid digital access key, but rather by other means, for example a combination of username and password, in particular using two-factor authentication, is received in step S20 at the administration terminal 30. This approval is then made available to the remote computing apparatus in a further step S21. In response to this, the generation information for the digital access key is then generated on the remote computing apparatus 20 in a step S22 and, in response to this, the requested generation information comprising the digital access key is made available to the first user terminal 40 in a further step S23. In particular, a digital access key is no longer completed here, in particular not on the basis of further generation information.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

3 Administration user

4 First user

5 Second user

10 Motor vehicle

20 Remote computing apparatus

30 Administration terminal

40 First user terminal

50 Second user terminal

100 Device

110 Type of generation

110a Alternative

120 Type of generation

120a Alternative

S1 Method step

S2 Method step

S3 Method step

S4 Method step

S5 Method step

S6 Method step

S7 Method step

S8 Method step

S9 Method step

S10 Method step

S11 Method step

S12 Method step

S13 Method step

S14 Method step

S15 Method step

S16 Method step

S17 Method step

S18 Method step

S19 Method step

S20 Method step

S21 Method step

S22 Method step

S23 Method step

What is claimed is:

1. A method for providing generation information relating to a digital access key for a motor vehicle, the method comprising steps of:
receiving, at a remote computing apparatus, a generation request to generate a digital access key for a motor vehicle;
retrieving a generation limit for digital access keys; and,
when the generation limit has been reached:
providing an administration terminal with an approval request;
receiving an administrator input from an administration user at the administration terminal; and
when the administrator input comprises an approval of the generation limit:
providing generation information for a digital access key by means of the remote computing apparatus.

2. The method according to claim 1, further comprising:
receiving a generation limit for digital access keys from the administration terminal at the remote computing apparatus);
wherein the step of receiving a generation request at the remote computing apparatus is carried out in response to the reception of a generation limit.

3. The method according to claim 2, further comprising:
providing a user terminal, with the administration terminal, with generation information for a digital access key;
wherein the generation request received at the remote computing apparatus is based on the generation information from the user terminal.

4. The method according to claim 3, wherein:
the step of receiving a generation limit at the remote computing apparatus is carried out in response to the administration terminal providing the user terminal with generation information for a digital access key.

5. The method according to claim 1, wherein:
the administrator input comprises a signature with a valid digital access key.

6. The method according to claim 1, wherein:
the generation limit comprises a generation limit for digital access keys for a predetermined motor vehicle.

7. The method according to claim 1, wherein:
the generation limit comprises a generation limit for digital access keys for a predetermined user.

8. The method according to claim 1, wherein:
the generation limit comprises a generation limit for digital access keys for a predetermined period.

9. The method according to claim 1, wherein:
the generation limit comprises a generation limit for a predetermined number of digital access keys.

10. A device configured to provide generation information relating to a digital access key for a motor vehicle, comprising one or more processors configured to execute the method according to claim 1.
